(19) United States
(12) Patent Application Publication
(10) Pub. No.: US 2012/0267020 A1
(43) Pub. Date: Oct. 25, 2012

(54) VEHICLE PNEUMATIC TYRE FOR UTILITY VEHICLES

(75) Inventors: Thomas Buchinger-Barnstorf, Wennigsen (DE); Jens Kleffmann, Hannover (DE); Klaus Peters, Burgdorf (DE)

(73) Assignee: CONTINENTAL REIFEN DEUTSCHLAND GMBH, Hannover (DE)

(21) Appl. No.: 13/517,203

(22) PCT Filed: Nov. 23, 2010
(86) PCT No.: PCT/EP10/67970

§ 371 Date: Jun. 19, 2012

(30) Foreign Application Priority Data
Mar. 4, 2010 (DE) 10 2010 000 637.8

(51) Int. Cl. B60C 11/117; B60C 11/11

(52) U.S. Cl. 152/209.18

(57) ABSTRACT

The invention relates to a vehicle pneumatic tyre for utility vehicles having a tread (1) which is composed of a radially outer, profiled region (6) and a trimming margin (7) which adjoins this profiled region (6) radially on the inside, and the profiled region has a certain gross volume, wherein the profiled region (6) has a radial thickness (a) and at least two circumferential grooves (3), running in the circumferential direction, of a certain radial depth (4). The invention is deleted by the fact that the groove volume (V_{R}) is less than or equal to 16% of the gross volume of the profiled region (V_{pB}), that the profiled region (6) has a radial thickness (a) of 6-25 mm, and that the trimming margin has a radial thickness (h) greater than 5 mm.

The invention relates to a vehicle pneumatic tire for utility vehicles, having a tread which is composed of a radially outer, profiled region and a trimming margin which adjoins this profiled region radially on the inside, and wherein the profiled region has a certain gross volume.

In particular truck tires are known which can be trimmed by the arrangement of a trimming margin in order to increase the kilometrage of the tire. The trimming margin is a rubber layer which adjoins the profiled region radially on the inside and into which the profile geometry of the largely worn away profiled region can be subsequently cut. The trimming makes available an additional profile depth and the kilometrage of the tire is increased.

The profiled region has a radial thickness (a) and at least two circumferential grooves, running in the circumferential direction, of a certain radial depth, which circumferential grooves divide the profiled region into circumferential ribs, wherein a first envelope (h1) which runs in the tread, parallel to the tread periphery, and which is in contact with the deepest circumferential groove or grooves radially from the inside, defines the profiled region together with the tread periphery and the shoulder-side edge sections, and wherein all the grooves define a certain groove volume in the profiled region. The trimming margin has a radial thickness (b), and wherein an envelope (h2), which runs in the tread, parallel to the tread periphery, and is in contact with the most deeply trimmable circumferential groove or grooves radially from the inside, defines the trimming margin together with the first envelope (h1) and the shoulder-side edge sections.

The gross volume of the profiled region is defined by the volume formed by the first envelope (h1) together with the tread periphery and the shoulder-side edge sections.

The maximum trimming depth and therefore the radial thickness of the trimming margin is the legally prescribed trimming recommendation which has to be specified by the tire manufacturer in the case of trimmable tires.

A residual rubber cushion is arranged between the trimming margin and the belt package which is located radially on the inside. This residual rubber cushion is also referred to as the “base cushion” and according to the subject matter of the invention it is not part of the trimming margin. The residual rubber cushion is intended to prevent extraneous bodies from penetrating the belt package and the carcass.

Trimming recommendations as far as the depth of 4.5 mm are known. For example, the Continental utility vehicle tire HDR of the size 11.00 R 22 has a recommended trimming depth of 4.0 mm, the HSR of the size 12.00 R 24 has a recommended trimming depth of 2.5 mm, and the HSR 11.00 R 22 has a recommended trimming depth of 3.5 mm.

A large number of measures have already been proposed for lowering the rolling resistance of vehicle pneumatic tires, these being, for example, to reduce the profile depth or to decrease the width of the tread. These measures are aimed at reducing the rubber volume to be deformed during rolling. Furthermore, specific tread compounds reduce the rolling resistance, said compounds being, for example, those which have a small proportion of filler material.

JP-A-61037504 has disclosed a passenger car tire whose tread is composed of a profiled region of the radial thickness (a) and a trimming margin, of the radial depth (b), adjoining this profiled region radially on the inside. The profiling has a maximum radial depth and therefore a thickness (a) of 3-5 mm. The thickness of the profiled region and the thickness of the trimming margin have the following relationship with one another: (a)+(b)=1.5 to 3×(a). The above-mentioned tire design is intended to permit excellent lateral guidance of and noise generation by the tire, while the water drainage capability and the grip of the passenger car tire are to remain unaffected by the trimming over its service life. This document has nothing to say about measures for reducing the rolling resistance.

A large number of published patent applications and patents are concerned with the theme of reducing the rolling resistance of utility vehicle tires in order to reduce the fuel consumption of a vehicle. For example, EP 0 973 652 B1 therefore discloses a tire for the driven wheels of trucks whose tread is divided, for the purpose of reducing the rolling resistance, into blocks which are penetrated axially by slits. The blocks are also separated from one another by lateral grooves which are each provided with the further slits. Furthermore, a large number of longitudinal slits is provided.

The invention is based on the object of effectively reducing the rolling resistance of a utility vehicle tire by means of simple measures without adverse effects being expected on other tread properties as well as on the abrasion and the expected service life of the tire.

The stated object is achieved according to the invention in that the groove volume (V_{R}) is less than or equal to 16% of the gross volume of the profiled region (V_{pB}), in that the profiled region has a radial thickness (a) of 6-25 mm, and in that the trimming margin has a radial thickness (b) of more than or equal to 5 mm.

In utility vehicle tires which are embodied according to the invention, the rubber volume in the tread is increased while the radial thickness of the tread remains approximately the same compared to the treads according to the prior art. Contrary to the previous opinion of specialists in the field, this increase in the rubber volume in the tread surprisingly brings about a marked reduction in the rolling resistance. The tread is composed of the profiled region and the trimming margin. The combined effect of the characterizing features - the small groove volume, compared to the prior art, of less than or equal to 16% with respect to the gross volume of the profiled region, the reduced radial thickness of the profiled region, and the increased radial thickness of the trimming margin in the case of a known/constant thickness of the tread—the rubber volume of the tread is increased. This has a positive effect on the rolling resistance. As a result of the described measures, the rigidity of the profile in the radial direction is increased in such a way that the deformation amplitude of the tread is reduced to an extent which brings about overcompensation of the expected effect - worsening of the rolling resistance as a result of more rubber being available. The rolling resistance of the tire is therefore smaller, wherein the reduction in the rolling resistance which can be achieved compared to a tire which is embodied according to the prior art may be significant depending on the proportion of the groove volume in combination with the thickness of the trimming reserve when there is a “constant” overall tread thickness.

In the case of passenger car tires, the above-mentioned effect, specifically of reducing the rolling resistance by means of more rubber, cannot be achieved.

The rolling resistance of the utility vehicle tire is improved if the trimming margin has a thickness (b)>=0.6×a but of at least 5 mm.

The rolling resistance of the utility vehicle tire is further improved if the trimming margin has a thickness (b) of >=1×a.

The rolling resistance of the utility vehicle tire is also improved, in particular, if the trimming margin has a thickness (b)>=1.5×a.

In particular, the embodiment of the circumferential grooves and their number and radial depth influences the size of the groove volume and therefore the rolling resistance potential and the kilometrage potential. Basically, within the scope of the invention, at least one wide circumferential groove whose width at the tread periphery is between 5 mm and 20 mm and whose depth is between 6 mm and 25 mm can be arranged in the tread. Furthermore, according to the invention basically at least one narrow circumferential groove whose width at or near to the tread periphery is between 0.5 mm and 3 mm and whose depth is also between 6 mm and 25 mm can be provided in the tread.

The embodiment of the circumferential grooves in terms of shape also perfects the groove volume or the proportion of the gross volume formed by the groove volume. The embodiment of the circumferential grooves in terms of shape or geometry influences many important tread properties, for example the water drainage capability, the erosion behavior, the traction properties, the rolling noise and the like. It is therefore essential to embody the circumferential grooves in terms of their geometry or their cross section in such a way that, on the one hand, according to the invention they keep the proportion of the gross volume formed by the groove volume small, and on the other hand, they ensure the desired tread properties.

In order to reduce the groove volume it may be favorable to embody the circumferential grooves in the tread at different depths.

It is advantageous for the tread to have at least one trimming indicator which is arranged in a circumferential groove and/or in a lateral groove. The trimming indicator indicates the maximum recommended trimming depth. The trimming indicator is, for example, a radially extending recess whose base extends as far as the radial depth which corresponds to the trimming recommendation. The trimming indicator may be arranged, for example, in a punctiform fashion or running around the circumference of the tire. The trimming indicator does not contribute to the groove volume.

Treads according to the invention may have in the circumferential ribs lateral grooves, recesses and the like whose “air volume” contributes to the groove volume.

The thicknesses of the profiled region and of the trimming margin are measured in the radial direction of the tire.

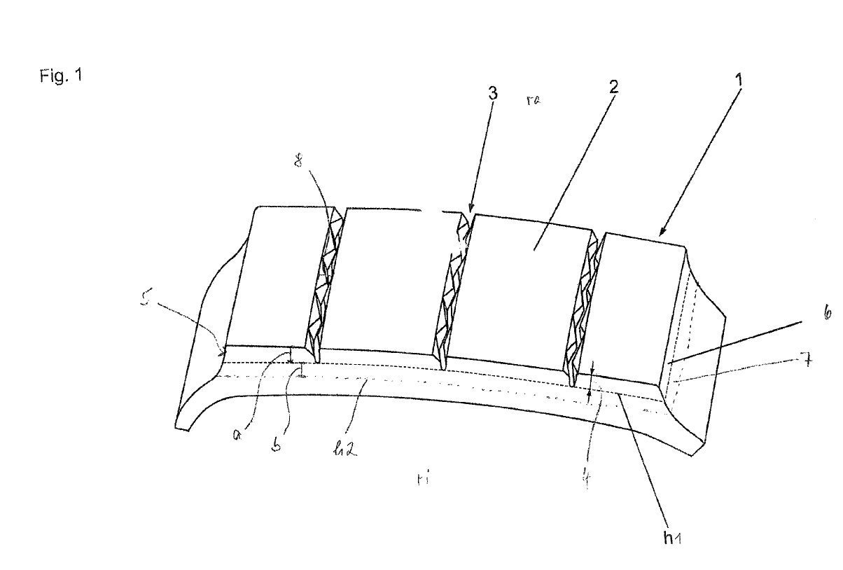

Further features, advantages and details of the invention will now be described in more detail with reference to a single drawing which illustrates a schematic exemplary embodiment, and with reference to a table. In this context, FIG. 1 shows a view of an embodiment of a tread of a utility vehicle tire according to the invention, and the table shows measured rolling resistances of utility vehicle tires embodied according to the invention.

The invention is concerned with a particular embodiment of treads for utility vehicle tires, in particular truck tires, bus tires and trailer tires. According to the invention, tires which are embodied according to the invention are preferably designed for use on the trailer axle of corresponding vehicles and may have the customary design of radial pneumatic tires for these purposes of use. The design is therefore neither presented nor described.

FIG. 1 shows a tread 1 of a new tire for a utility vehicle, which tire is composed of a radially outer, profiled region 6 of the thickness (a) and a radially inner trimming margin 7 of the thickness (b). The profiled region 6 has a thickness (a) of 12 mm, and the trimming margin 7 has a thickness (b) of 7 mm. The profiled region 6 has four circumferential ribs 2, running in the circumferential direction of the tread, of essentially corresponding widths. The circumferential ribs 2 are separated from one another by wide circumferential grooves 3 which run in a circumferential direction and which are all embodied in a corresponding way. Maximum depth of the wide circumferential grooves 3, which is selected to be of the same size for all the circumferential grooves 3 in the embodiment shown, is between 6 mm and 25 mm, here 12 mm. Two auxiliary lines h1 and h2 are shown parallel to the outer contour of the tread periphery. The first auxiliary line hl symbolizes an envelope h1 which runs around in the circumferential direction within the tread 1, is in contact with the wide circumferential grooves 3 at their radially inner ends and in this way runs parallel in cross section to the tread periphery in the circumferential direction within the tread 1. The first auxiliary line hl bounds the profiled region 6 in the radially inner direction with respect to the trimming margin 7. The second auxiliary line h2 bounds the trimming margin 7 in the radially inner direction and runs parallel to the first auxiliary line h1 and encloses the trimming margin 7 between it and the auxiliary line h1. The envelope which is symbolized by the auxiliary line h1, the tread periphery and the shoulder-side edge sections 5 of the tread 1 enclose a gross volume of the profiled region V_{pB} which is the sum of the rubber volume located here and the groove volume V_{R}.

In a tire which is embodied according to the invention, the proportion of the gross volume V_{pB} formed by the groove volume V_{R} is between 1% and 16%, preferably a maximum of 10%, and particularly preferably between 1% and 7%, in particular preferably between 1% and 4%, while the trimming margin has a thickness (b)>=0.4×a, preferably (b)>=0.6×a, particularly preferably (b)>=1×a, in particular preferably (b)>=1.5×a, but at least 5 mm.

The table shows measured rolling resistances of a truck reference tire with a rolling resistance of 100% and of truck tires embodied according to the invention with improved rolling resistance.

TABLE

| | Thickness | | | Rolling |
|---|---|---|---|---|
| | of the | Trimming | | resistance |
| | profiled region | margin (b) | Ratio of (b) to | according to |
| | (a) in mm | in mm | (a) | ISO 28580 (%) |
| Reference | 15 | 4 | (b) = 0.3 × (a) | 100 |
| Trial 1 | 13.5 | 5.5 | (b) = 0.4 × (a) | 98.3 |
| Trial 2 | 12 | 7 | (b) = 0.6 × (a) | 97.1 |
| Trial 3 | 10.5 | 8.5 | (b) = 0.8 × (a) | 95.5 |
| Trial 4 | 9 | 10 | (b) = 1.1 × (a) | 94 |
| Trial 5 | 7.5 | 11.5 | (b) = 1.5 × (a) | 92.7 |
| Trial 6 | 6 | 13 | (b) = 2.2 × (a) | 91.5 |

The reference tire and the truck tires according to the invention have a groove volume of 14% with respect to the gross volume of the profiled region. The tread volume is composed of a profiled region with three circumferential grooves running in the circumferential direction.

The thickness of the profiled region corresponds to the radial depth (a) of the deepest circumferential grooves, while the radial thickness of the trimming margin (b) corresponds to the trimming depth recommended by the manufacturer.

The reference tire has a thickness of the profiled region (a) of 15 mm and a trimming margin (b) of 4 mm. The rolling resistance of the reference tire is 100%.

From the table it becomes clear that when truck tires are embodied according to the invention the rolling resistance is better the more rubber volume is made available in the tread. Increasing the thickness of the trimming margin (b) with a corresponding reduction in the thickness of the profiled region (a)—that is to say with a constant tread thickness—results in a larger rubber volume in the tread and therefore in an improved rolling resistance. The smaller the % specification of the rolling resistance, the better the rolling resistance of the truck tire.

### LIST OF REFERENCE SYMBOLS

1 Tread
2 Circumferential rib
3 Circumferential groove
4 Depth of the circumferential groove
5 Edge section
6 Profiled region
7 Trimming margin
8 Width of the circumferential groove
a Depth of the profiled region
b Depth of the trimming margin
h1 First auxiliary line/envelope
h2 Second auxiliary line/envelope
ri Radially on the inside
ra Radially on the outside

1. A vehicle pneumatic tire for utility vehicles, having a tread (1) which is composed of a radially outer, profiled region (6) and a trimming margin (7) which adjoins this profiled region (6) radially on the inside and the profiled region (6) has a certain gross volume (V_{pB}),
wherein the profiled region (6) has a radial thickness (a) and at least two circumferential grooves (3), running in the circumferential direction, of a certain radial depth (4), which circumferential grooves (3) divide the profiled region (6) into circumferential ribs (2), wherein a first envelope (h1) which runs in the tread (1), parallel to the tread periphery, and which is in contact with the deepest circumferential groove or grooves radially from the inside, defines the profiled region (6) together with the tread periphery and the shoulder-side edge sections (5), and wherein all the grooves (3) define a certain groove volume (V_{R}) in the profiled region (6),
wherein the trimming margin (7) has a radial thickness (b), and wherein an envelope (h2), which runs in the tread (1), parallel to the tread periphery, and is in contact with the most deeply trimmable circumferential groove or grooves radially from the inside, defines the trimming margin (7) together with the first envelope (h1) and the shoulder-side edge sections (5),
characterized
in that the groove volume (V_{R}) is less than or equal to 16% of the gross volume of the profiled region (V_{pB}), in that the profiled region (6) has a radial thickness (a) of 6-25 mm, and
in that the trimming margin has a radial thickness (b) of more than or equal to 5 mm.

2. The vehicle pneumatic tire as claimed in claim 1, characterized in that the proportion of the gross volume of the profiled region (V_{pB}) which is formed by the groove volume (V_{R}) is up to 10%.

3. The vehicle pneumatic tire as claimed in claim 1, characterized in that the proportion of the gross volume of the profiled region (V_{pB}) which is formed by the groove volume (V_{R}) is up to 7%.

4. The vehicle pneumatic tire as claimed in claim 1, characterized in that the proportion of the gross volume of the profiled region (V_{pB}) which is formed by the groove volume (V_{R}) is up to 4%.

5. The vehicle pneumatic tire as claimed in claim 1, characterized in that the profiled region (6) has a radial thickness (a) of 6-13 mm.

6. The vehicle pneumatic tire as claimed in claim 1, characterized in that the trimming margin (7) has a radial thickness (b)>=0.4×a, wherein the thickness (b) is at least 5 mm.

7. The vehicle pneumatic tire as claimed in claim 1, characterized in that the trimming margin (7) has a radial thickness (b)>=0.6×a, wherein the thickness (b) is at least 5 mm.

8. The vehicle pneumatic tire as claimed in claim 1, characterized in that the trimming margin (7) has a radial thickness (b)>=1×a.

9. The vehicle pneumatic tire as claimed claim 1, characterized in that the trimming margin (7) has a radial thickness (b)>=1.5×a.

10. The vehicle pneumatic tire as claimed in claim 1, characterized in that the profiled region (6) has at least one wide circumferential groove (3) whose width at the tread periphery is between 5 mm and 20 mm and whose depth (4) is between 6 mm and 25 mm.

11. The vehicle pneumatic tire as claimed in claim 1, characterized in that the profiled region (6) has at least one narrow circumferential groove whose width at or near to the tread periphery is between 0.5 mm and 3 mm and whose depth (4) is between 6 mm and 25 mm.

12. The vehicle pneumatic tire as claimed in claim 1, characterized in that the tread (1) has at least one trimming indicator which is arranged in a circumferential groove and/or in a lateral groove.
